(19) United States
(12) Patent Application Publication
(10) Pub. No.: US 2026/0053295 A1
(43) Pub. Date: Feb. 26, 2026

(54) Electric Immersion Element Deep Fryer With Water Collector

(71) Applicant: SEB S.A., Ecully (FR)

(72) Inventor: Guillaume Prieto, Ecully Cedex (FR)

(73) Assignee: SEB S.A., Ecully (FR)

(21) Appl. No.: 19/111,891

(22) PCT Filed: Sep. 13, 2023
(86) PCT No.: PCT/EP2023/075109

§ 371 Date: Mar. 14, 2025

(30) Foreign Application Priority Data
Sep. 16, 2022 (FR) FR2209371

(51) Int. Cl. A47J 37/12; H05B 3/82

(52) U.S. Cl. CPC A47J 37/1261; H05B 3/82; H05B 2203/016

(57) ABSTRACT

An electric deep fryer includes a vat configured to contain a frying bath, and an electric immersion heating element configured to be immersed in the frying bath contained in the vat. The vat has a bottom with a sloping part draining into a depression forming a water collection area. The sloping part has a slope change area extending between an upper bottom part and the depression. The electric immersion heating element has heating wires extending above the sloping part.

The heating wires extend above the upper bottom part without reaching the depression.

### TECHNICAL FIELD

The present invention relates to the technical field of electric deep fryers, also known as deep-fat fryers, in which food is fried by immersion in a frying bath. The frying bath can be oil, but also melted fat.

The present invention relates more specifically to electric immersion element deep fryers. These appliances comprise an electric heating element arranged in a vat for direct heating of the frying bath contained in said vat. Food in the frying bath loses water. The use of water-rich foods, and/or food that has been washed and not dried, contributes to this phenomenon. This water can sink to the bottom of the vat as droplets. Depending on the configuration of the vat, these droplets can collect at the bottom of the vat to form a significant volume of water. Because the electric heating element is immersed in the frying bath, the temperature of the frying bath will be lower below the electric heating element than above the electric heating element. However, if the temperature rises and this volume of water is abruptly vaporized, this volume of vaporized water then creates an abrupt expansion in the frying bath, which can generate substantial projections out of the vat holding said frying bath.

### PRIOR ART

Document DE19907072 discloses an immersion element deep fryer comprising a vat with a bottom that has a sloping part draining into a collection area in which the temperature is below 100° C. However, the immersion element extends above the collection area. To avoid explosion phenomena generated by water from food, this document provides a vat with sloping parts around a central collection area. One drawback of the proposed embodiment is that the immersion element extends above the collection area, which requires a significant vat height to reduce the temperature in this area.

### SUMMARY OF THE INVENTION

One of the purposes of the present invention is to provide an electric immersion element deep fryer, which makes it possible to avoid explosion phenomena caused by the vaporization of the water contained in the vat, with a design that remains economical.

One of the purposes of the present invention is to provide an electric immersion element deep fryer, which makes it possible to avoid explosion phenomena caused by the vaporization of the water contained in the vat, with a design that remains compact.

These purposes are achieved with an electric deep fryer, comprising a vat designed to contain a frying bath, and an electric immersion heating element configured to be immersed in the frying bath contained in the vat, the vat having a bottom with a sloping part draining into a depression forming a water collection area, the sloping part having a slope change area extending between an upper bottom part and the depression, the electric immersion heating element having heating wires extending above the sloping part, in that the heating wires extend above the upper bottom part without reaching the depression. In effect, if the heating wires are too close to the water collection area, the temperature of the water collected in the water collection area will rise rapidly and there is still a risk of explosion.

The heating wires can extend above the upper bottom part without reaching the slope change area. This arrangement makes it possible to reduce the risk of explosion even further.

The upper bottom part can form most of the surface of the bottom. This arrangement also makes it possible to increase the surface area above which the heating wires extend.

The upper bottom part can have a minimum slope greater than or equal to 5°. This arrangement allows water from the food to flow more easily towards the depression forming a water collection area.

The upper bottom part can have an average slope of less than or equal to 10°. This arrangement allows for a reduction in the height of the vat.

The heating wires can extend towards the depression. This arrangement makes it easier to design the electric immersion heating element.

The heating wires can be angled downwards towards the depression. This arrangement allows part of the water to be vaporized, while the remainder is collected in the depression forming the water collection area.

The angle of the heating wires can match the slope of the upper bottom part. This arrangement provides a uniform clearance between the heating wires and the upper bottom part.

The geometry of the vat can be elongated in one direction. This arrangement simplifies the design of the electric deep fryer.

The sloping part can be sloped in said direction. This arrangement allows for a reduction in the height of the vat.

The depression can be arranged at one end of the vat opposite the electric immersion heating element. This arrangement allows for a reduction in the height of the vat.

The geometry of the vat can be rectangular, with two short sides and two long sides. This arrangement simplifies the design of the electric deep fryer.

The slope change area can connect the two long sides.

The two short sides can be of different heights.

The sloping part can extend from the short side with the shortest height.

The depression can be delimited by the short side with the tallest height.

The depression can extend to both long sides.

A basket can be arranged in the vat above the electric immersion heating element.

The basket can have a bottom sloping towards the depression. This allows for increased basket capacity.

The slope of the bottom of the basket can match the angle of the heating wires. This arrangement allows for optimum basket capacity.

### BRIEF DESCRIPTION OF THE DRAWINGS

The invention will be better understood from the study of an exemplary embodiment, taken without any limitation, illustrated in the attached FIGS. 1 to 4, in which:

FIG. 1 shows an elevational and cross-sectional view of an exemplary embodiment of an electric deep fryer according to the invention,

FIG. 2 shows a perspective view from below of the electric deep fryer shown in FIG. 1,

FIG. 3 shows a perspective view from the side of the vat and of the electrical subassembly of the electric deep fryer shown in FIGS. 1 and 2,

FIG. 4 shows a perspective view from above of the electric deep fryer shown in FIGS. 1 and 2, in which the lid and basket have been removed.

### DESCRIPTION OF THE EMBODIMENTS

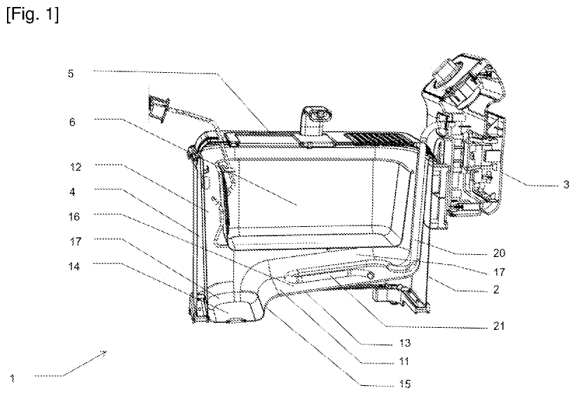

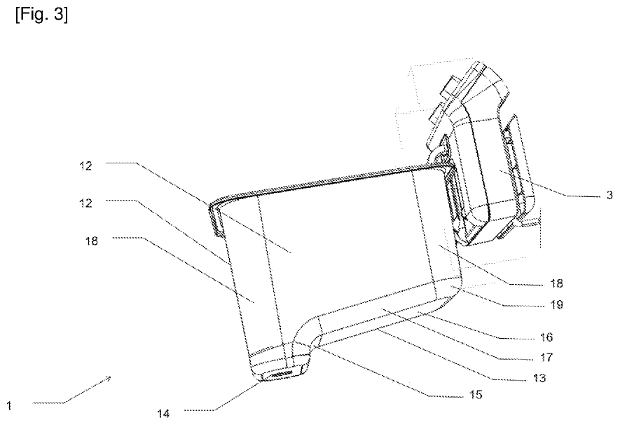

The electric deep fryer 1 shown in FIGS. 1 to 4 comprises a vat 4 designed to contain a frying bath, and an electric immersion heating element 20 configured to be immersed in the frying bath contained in the vat 4.

The electric immersion heating element 20 has heating wires 21 extending above a bottom 11 of the vat 4. The electric immersion heating element 20 is connected to a control unit 3. If the electric immersion heating element 20 extends inside the vat 4, the control unit 3 extends outside the vat 4. The electric immersion heating element 20 can be combined with a temperature control device and a thermal safety device, not shown in the figures. The temperature control device is, for example, a thermostat. The thermal safety device is, for example, a thermal fuse or a resettable thermal limiter.

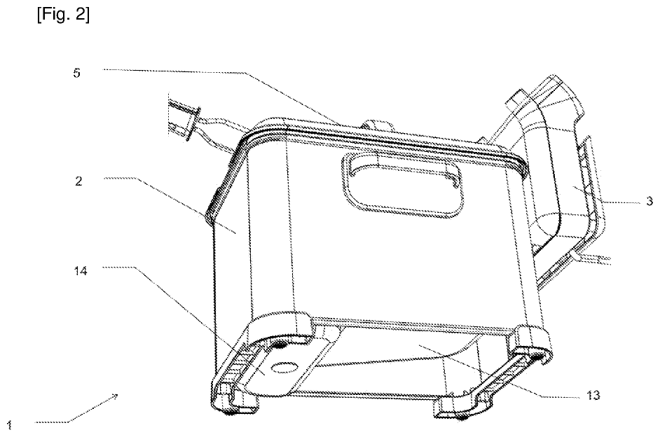

The electric deep fryer 1 can comprise an outer housing 2 holding the vat 4. As shown more clearly in FIGS. 1 and 2, the outer housing 2 forms a four-sided apron. The outer housing 2 comprises housing feet, which can be better seen in FIG. 2.

In the embodiment illustrated in the figures, the vat 4 is removably mounted in the outer housing 2. According to a usual embodiment, the vat 4 has an outer edge configured to rest on an upper edge of the outer housing 2, as can be better seen in FIGS. 1 and 2. As an alternative, the vat 4 could in particular be attached to the outer housing 2, or the electric deep fryer 1 could, in particular, have no outer housing 2.

The electric deep fryer 1 can comprise a lid 5 provided to cover the vat 4. If desired, the lid 5 can be configured to be used in the operating configuration. Alternatively, the lid 5 can be configured to be used only in a storage configuration.

The electric deep fryer 1 can comprise a basket 6 configured to contain food immersed in a frying bath contained in the vat 4. As shown in FIG. 1, the basket 6 is arranged in the vat 4 above the electric immersion heating element 20.

In the exemplary embodiment shown in the figures, the vat 4 has several side walls 12. Lower connecting walls 17 can connect the bottom 11 to each of the side walls 12. Side connecting walls 18 can connect two adjacent side walls 12. Corner connecting walls 19 can connect two lower connecting walls 17 to the adjacent side wall 18.

More specifically, in the exemplary embodiment shown in the figures, the geometry of the vat 4 is rectangular, with two short sides 10a, 10b and two long sides 10c, 10d.

As can be better seen in FIG. 1, the bottom 11 of the vat 4 has a sloping part 13 that drains into a depression 14 forming a water collection area. The sloping part 13 involves the bottom 11 of vat 4 and not the lower connecting walls 17 between the bottom 11 and the side walls 12 of the vat 4.

More specifically, the sloping part 13 has a slope change area 15 extending between an upper bottom part 16 and the depression 14. In other words, the slope change area 15 forms a step between the upper bottom part 16 and the depression 14.

The slope of the upper bottom part is not necessarily uniform.

Preferably, the upper bottom part 16 has a minimum slope greater than or equal to 5°, to facilitate the flow of water to the depression 14.

Preferably, the upper bottom part 16 has an average slope of less than or equal to 10°, allowing for a reduction in the height of the vat 4.

The slope change area 15 has an average slope that is greater than the average slope of the upper bottom part 16. The slope change area 15 can have a maximum slope greater than 45°, and preferably greater than 60°.

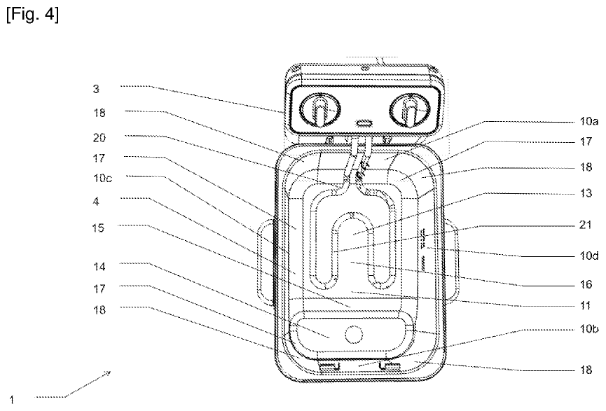

The heating wires 21 of the electric immersion heating element 20 extend above the sloping part 13, more specifically above the upper bottom part 16. Indeed, as can be clearly seen in FIGS. 1 and 4, the heating wires 21 do not reach the depression 14. In other words, the heating wires 21 do not extend above the depression 14.

Preferably, the heating wires 21 do not reach the slope change area 15. In other words, the heating wires 21 do not extend above the slope change area 15.

In the exemplary embodiment shown in the figures, the heating wires 21 extend towards the depression 14. In other words, the heating wires 21 extend in the direction of the slope of the upper bottom part 16.

More specifically, in the exemplary embodiment shown in the figures, the heating wires 21 are angled downwards towards the depression 14. The angle of the heating wires 21 matches the slope of the upper bottom part 16.

In the exemplary embodiment shown in the figures, the geometry of the vat 4 is elongated in one direction. The sloping part 13 is sloped in said direction.

As can be clearly seen in FIG. 4, the upper bottom part 16 forms most of the surface of the bottom 11. The slope change area 15 connects the two long sides 10c, 10d. The depression 14 is arranged at one end of the vat 4 opposite the electric immersion heating element 20. Due to the presence of the depression 14, the two short sides 10a, 10b are of different heights. The sloping part 13 extends from the short side 10a with the shortest height. The depression 14 is delimited by the short side 10b with the tallest height. The depression 14 extends to both long sides 10c, 10d.

The electric deep fryer 1 shown in FIGS. 1 to 4 is used as follows.

The user places the vat 4 in the outer housing 2, places the electric immersion heating element 20 in the vat 4, adds a frying bath to the vat 4, and turns on the electric deep fryer 1 to heat the electric immersion heating element 20. When the temperature of the frying bath has reached a satisfactory temperature level, the user can immerse food in the frying bath, preferably by placing it in the basket 6. The water contained in the food is gradually vaporized by the temperature of the frying bath. However, if water sinks to the bottom of vat 4, it is collected by the bottom 11 of vat 4, in particular by the sloping part 13 or the depression 14. The sloping part 13 directs the collected water to the depression 14 unless this water is vaporized by the heating wires 21. The upper bottom part 16 draining towards the slope change area 15 allows the water to drain out of the area covered by the heating wires. The slope change area 15 facilitates rapid draining of the water to the depression 14. The depression 14 makes it possible to collect the water along with the cooking residues. The depth of the depression 14 is designed to keep the temperature of the lower part of the frying bath well below the water vaporization temperature while the electric deep fryer 1 is in operation, in order to avoid the vaporization of large amounts of water, which could lead to explosions.

As a variant, the vat 4 does not necessarily have several side walls 12. In particular, the geometry of the vat 4 could be circular or elliptical.

As a variant, the basket 6 does not necessarily have a bottom parallel to the supporting plane of the electric deep fryer 1. The basket 6 can, in particular, have a bottom sloping towards the depression 14. In a preferred embodiment, the slope of the bottom of the basket can match the angle of the heating wires 21.

Various modifications and/or improvements that are obvious for the person skilled in the art can be made to the embodiment of the invention described in this description without departing from the scope of the invention defined by the claims.

1. An electric deep fryer comprising a vat configured to contain a frying bath, and an electric immersion heating element configured to be immersed in the frying bath contained in the vat, the vat having a bottom with a sloping part extending into a depression forming a water collection area, the sloping part having a slope change area extending between an upper bottom part and the depression the electric immersion heating element having heating wires extending above the sloping part, wherein the heating wires extend above the upper bottom part without reaching the depression

2. The electric deep fryer according to claim 1, wherein the heating wires extend above the upper bottom part without reaching the slope change area

3. The electric deep fryer according to claim 1, wherein the upper bottom part forms most of the surface of the bottom

4. The electric deep fryer according to claim 1, wherein the upper bottom part has a minimum slope greater than or equal to 5°.

5. The electric deep fryer according to claim 1, wherein the upper bottom part has an average slope of less than or equal to 10°.

6. The electric deep fryer according to claim 1, wherein the heating wires extend towards the depression.

7. The electric deep fryer according to claim 1, wherein the heating wires form an angle downwards towards the depression.

8. The electric deep fryer according to claim 17, wherein the angle of the heating wires matches a slope of the upper bottom part.

9. The electric deep fryer according to claim 1, wherein the vat is elongated in a first direction.

10. The electric deep fryer according to claim 9, wherein the sloping part is sloped in the first direction.

11. The electric deep fryer according to claim 9, wherein the depression is positioned at a first end of the vat opposite the electric immersion heating element

12. The electric deep fryer according to any claim 1, wherein the vat is rectangular, with two short sides and two long sides.

13. The electric deep fryer according to claim 12, wherein the slope change area connects the two long sides.

14. The electric deep fryer according to claim 12, wherein the two short sides have different heights.

15. The electric deep fryer according to claim 14, wherein the sloping part extends from a first short side of the two short sides, the first short side having a lesser height among the two short sides

16. The electric deep fryer according to claim 14, wherein the depression is delimited by the a first short side of the two short sides, the first short side having a greater height among the two short sides.

17. The electric deep fryer according to claim 12, wherein the depression extends to both of the two long sides

18. The electric deep fryer according to claim 1, wherein a basket is arranged in the vat above the electric immersion heating element

19. The electric deep fryer according to claim 18, wherein the basket has a bottom defining a slope towards the depression

20. The electric deep fryer according to claim 19, wherein the slope of the bottom of the basket matches an angle of a slope of the heating wires.
